(19) United States
(12) Patent Application Publication
(10) Pub. No.: US 2026/0177576 A1
(43) Pub. Date: Jun. 25, 2026

(54) CARRIER FOR A SAMPLE HOLDER, TRANSPORTER FOR THE CARRIER AND ANALYSIS SYSTEM

(71) Applicant: Leica Microsystems CMS GmbH, Wetzlar (DE)

(72) Inventor: Stefan CHRIST, Wetzlar (DE)

(21) Appl. No.: 19/127,414

(22) PCT Filed: Jun. 27, 2023
(86) PCT No.: PCT/EP2023/067368

§ 371 Date: May 6, 2025

(51) Int. Cl. G01N 35/04; G01N 1/30; G01N 1/31; G01N 35/00

(52) U.S. Cl. CPC G01N 35/04; G01N 1/30; G01N 1/31; G01N 1/312; G01N 35/00029; B01L 2300/0609

(57) ABSTRACT

A carrier for a sample holder includes a frame defining a holding space to receive the sample holder. The frame is configured to enclose the sample holder at least partially on a plurality of sides. The frame is configured to enable visual inspection of at least a sample area of the sample holder. The frame includes at least one handling structure configured to be engaged by a handling device.

### CROSS REFERENCE TO RELATED APPLICATIONS

This application is a U.S. National Phase application under 35 U.S.C. § 371 of International Application No. PCT/EP 2023/067368, filed on Jun. 27, 2023. The International Application was published in English on Jan. 2, 2025 as WO 2025/002533 A1 under PCT Article 21(2).

### FIELD

Embodiments of the present invention relate to a carrier for a sample holder, a transporter for transporting the carrier and an analysis system comprising the transporter. In a further aspect, embodiments of the present invention provide a method for analysing biological sample in the carrier.

### BACKGROUND

Systems are known for analysing biological samples such as tissue sections to determine the spatial distribution of target analytes within the biological samples. This generally relies on staining with optically detectable, in particular fluorescent, markers that are specific to the respective analytes.

Often these samples are mounted on sample holders to allow handling of individual samples, for example, for analysis of these individual samples. A particularly important aspect of this analysis relies on successfully staining these samples repeatedly and reproducibly, and imaging these samples.

### SUMMARY

Embodiments of the present invention provide a carrier for a sample holder. The carrier includes a frame defining a holding space to receive the sample holder. The frame is configured to enclose the sample holder at least partially on a plurality of sides. The frame is configured to enable visual inspection of at least a sample area of the sample holder. The frame includes at least one handling structure configured to be engaged by a handling device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic top view of a carrier for a sample holder according to some embodiments;

FIG. 2 is a schematic top view and side view of the carrier according to FIG. 1 with the sample holder according to some embodiments;

FIG. 3 is a schematic top view of the carrier according to FIG. 1 with the sample holder and a handling device according to some embodiments;

FIG. 4 is a schematic side view of the carrier according to FIG. 1 with the sample holder and a handling device according to some embodiments;

FIG. 5 is a schematic top view and a side view of a transporter for transporting the carrier according to FIG. 1 according to some embodiments;

FIG. 6 is a schematic top view and a side view of a further transporter for transporting the carrier according to FIG. 1 according to some embodiments;

FIG. 7 is a schematic side view of the carrier engaged with the transporter according to FIG. 6 according to some embodiments;

FIG. 8 is a top view of a further transporter for transporting the carrier according to FIG. 1 according to some embodiments;

FIG. 9 is a schematic view of an analysis system comprising a stainer, and imager and the transporter according to FIG. 5 according to some embodiments;

FIG. 10 is a detailed schematic view of the analysis system according to FIG. 9 according to some embodiments;

FIG. 11 is a schematic view of a further analysis system according to some embodiments;

FIG. 12 is a detailed schematic view of a storing unit of the analysis system according to FIG. 11 according to some embodiments; and

FIG. 13 is a schematic view of the analysis system according to FIG. 9 with an operating unit according to some embodiments.

### DETAILED DESCRIPTION

Embodiments of the present invention provide means and a method for efficiently handling and analysing of samples mounted on sample holders.

According to some embodiments, a carrier comprises: a frame defining a holding space configured to receive the sample holder; wherein the frame is configured to enclose the sample holder at least partially on a plurality of sides, in particular of the sample holder; wherein the frame is configured to enable visual inspection of at least a sample area of the sample holder; and wherein the frame comprises at least one handling structure configured to be engaged by a handling device.

The carrier provides a dedicated common interface between sample holders and the handling device in form of the handling structure configured to be engaged by the handling device. This increases the efficiency of handling a large number of sample holders and of sample holders of different dimensions. The sample holder being configured to hold a sample, in particular, a biological sample, in the sample area. In addition, the risk of cross contamination between samples is reduced when handling a large number of sample holders, since the sample holder is not in direct contact with the handling device. Moreover, providing the carrier for a sample holder may reduce abrasion of the sample holder since the sample holder is not in repeated contact with the handling device, instead the dedicated handling structure is. This reduces debris from wear and tear of the sample holder. This is of particular importance in analysis systems for analysing samples on sample holders, in which debris generation is generally undesirable. This is especially important for glass slide sample holders, due to glass debris being particularly abrasive. Further, the sample may be stained and/or imaged when the sample holder with the sample is in the carrier.

The sample holder may be a microscope slide or a glass slide, for example. Preferably, the carrier is configured such that when the sample holder is received by the carrier, the sample, in particular the sample area, is visible from a side of the sample holder where the sample is arranged and an opposite side of the sample holder. To this end, the frame of the carrier may, in particular, have a cut-out or a transparent side towards the sample area of the sample holder. The engagement of the handling structure by the handling device is preferably reversible. The engagement of the handling structure by the handling device enables movement of the carrier along at least two axes (x, y), preferably along three axes (x, y, z).

Preferably, the frame comprises a circumferential seal configured to seal against the sample holder. This seals the holding space on one side of the sample holder.

Preferably, the frame of the carrier comprises a liquid inlet configured to stream a liquid into the holding space. In particular, the liquid inlet channels through the frame of the carrier and has an opening towards the holding space. This enables efficiently adding a liquid to the holding space.

Preferably, the liquid inlet comprises a distribution section configured to evenly distribute the liquid at least across the sample area of the sample holder, in particular, across the sample. In particular, an opening of the liquid inlet towards the holding space comprises the distribution section. For example, the distribution section may be a pipe section widening towards the holding space. This enables efficiently streaming a liquid, for example, a staining reagent, across the sample on the sample holder when the sample holder is in the carrier.

Preferably, the frame comprises a liquid outlet configured to remove liquid from the holding space. In particular, the liquid outlet has an opening towards the holding space. This enables efficiently removing liquid from the holding space.

Preferably, the frame is configured to receive the sample holder in a recessed position within the frame. This enables efficiently submerging the sample area of the sample holder, in particular, the sample, in a liquid. When submerging the sample area, the liquid is held between the frame and at least one side of the sample holder comprising the sample area.

Preferably, the carrier comprises at least one holding element configured to hold the sample holder in the holding space of the carrier. This enables securely holding the sample holder within the carrier. In particular, the holding element is movably attached to the frame. Further, the holding element may be configured to press the sample holder against the seal.

Preferably, the handling structure is fixedly connected to the frame of the carrier. This enables easy and robust construction of the carrier.

Preferably, the handling structure is configured to be engaged by the handling device by friction fit and/or by form fit. This enables particularly robust engagement of the handling structure with the handling device.

In another aspect a transporter for transporting the carrier is provided, comprising: at least one transport belt; a drive configured to move the at least one transport belt; and at least one handling device configured to engage the at least one handling structure of the carrier.

The handling device may engage the handling structure and guide the carrier along a transport path when the belt is moving and transporting the carrier, for example. Alternatively, the handling device may engage the handling structure and the engaged handling device may be moved by the belt to transport the carrier. This enables efficient transport of the carrier.

Preferably, the handling device is fixedly connected to the transport belt. In particular, the transport belt comprises the at least one handling device. Thus, the handling device engaged with the handling structure moves the carrier when the belt is moving.

This enables easy and robust construction of the transporter.

Preferably, the transport belt comprises one of a tongue or a groove configured to engage a corresponding complementary tongue or a groove arranged on the carrier. This keeps the carrier safely aligned with the belt. The tongue or groove may be the handling device or handling structure. Alternatively, the tongue or groove are in addition to the handling device and the handling structure.

In another preferred embodiment of the transporter, the handling device comprises a plurality of wheels configured to engage the handling structure of the carrier. The transport belt may drive the wheels. For example, the transporter may comprise two sets of wheels between which the carrier may be transported. During the transport, the wheels turn and engage the handling structures of the carrier on either side of the carrier in order to transport the carrier. Preferably, the wheels may be driven by the transport belt.

Preferably, the handling device is stationary. Thus, the handling device may, in particular, not move with the carrier when transporting the carrier. This enables a particularly robust transporter.

In a further preferred embodiment of the transporter, the handling device may comprise a gripping mechanism.

In a further aspect, an analysis system for analysing biological samples is provided, comprising: a stainer configured to receive at least one carrier and to stain a biological sample in the sample area of the sample holder receivable by the carrier; an imager configured to receive the at least one carrier and to image the biological sample in the sample area; and at least one transporter configured to transport the carrier at least between the stainer and the imager.

The analysis system enables the efficient analysis of samples provided on sample holders by efficiently transporting the sample holders in carriers to the stainer to be stained and to the imager, for example, a microscope, to be imaged. The analysis system enables automation of the analysis of the samples and therefore efficient, reproducible analysis. Preferably, the analysis system comprises at least one of the carriers.

Preferably, the stainer comprises a liquid handling device configured to engage the liquid inlet and the liquid outlet of the carrier. This enables efficiently applying liquids, such as staining reagents, to the sample on the sample holder in the carrier.

Preferably, the analysis system comprises at least one storing unit configured to receive and to store the at least one carrier. In particular, the transporter may also transport the carrier to the storing unit. This enables efficient analysis of a large number of samples, in particular, iterative staining of these samples.

Preferably, the storing unit comprises a climate control device configured to control at least one of a temperature, a humidity, and a pressure within the storing unit. This enables efficient processing of a large number of carriers, in particular, efficient staining of a large number of samples. In particular, the storing unit includes a closed storing space for storing the carriers, within which the climate may be controlled. The temperature of the carriers may be controlled directly, for example, by conductive heating elements rather than via control of an air temperature within the storing unit. The pressure, in particular, an air pressure, within the storing space may be controlled by the climate control device. Thus, the housing may be configured to contain pressure.

Preferably, the analysis system further comprises an operating unit configured to control at least the stainer, the imager and the at least one transporter of the analysis system. This enables efficient control and operation of the analysis system. In particular, a single operating unit is provided configured to exclusively control the analysis system. Specifically, when a plurality of carriers with samples is analysed by the analysis system at a particular time, the operating may be configured to keep track of each carrier and direct each carrier to the stainer, imager, or storing unit at required times. In addition, the operating unit may include a single panel for input and/or output to a user of the analysis system. This allows the user to choose a specific analysis routine based on the markers used to mark the sample and track progress of the analysis, for example.

Preferably, the analysis system may comprise means, such as a reader, to read-out the label of the sample holder. This enables identifying and tracking individual carriers with sample holders and samples when transporting the carriers through the analysis system by means of the transporter.

In a further aspect, a method for analysing a biological sample by means of the analysis system is provided, comprising the steps: providing at least one biological sample on a sample holder in a carrier; staining the biological sample by means of the stainer; transporting the carrier with the stained biological sample to the imager by means of the transporter; imaging the stained biological sample by means of the imager. This enables efficient analysis of the biological samples provided on the sample holder in the carrier.

Preferably, the operating unit of the analysis system is configured to carry out the method for analysing the biological sample.

In particular, the step of staining the biological sample by means of the stainer may include applying at least a first marker, for example, a mAb-or nucleotide-based marker, to the biological sample in order to mark a respective target analyte. The first marker may be applied by means of the liquid handling device of the stainer. The markers may be a dye conjugated with an affinity reagent, for example, fluorophore conjugated antibodies, or alternatively, FISH-probes.

Preferably, the step of staining includes transporting the carrier to the storing unit by means of the transporter in order to incubate the biological sample. Particularly, this may follow applying the first marker by the stainer. This enables efficiently processing a large number of carriers. For example, staining the biological sample with a nucleotide-based marker may include incubation at an elevated temperature in the storing unit in order to cause hybridisation of the nucleotide-based marker to the respective target analyte. Thus, the sample may be incubated with the marker at conditions that enables a staining reaction to proceed efficiently. Moreover, the sample may be incubated for a set period of time for a staining reaction to complete. In the meantime, further samples may be stained by means of the stainer and subsequently incubated in the storing unit.

Preferably, the steps of staining the biological sample, transporting the carrier and imaging the stained biological sample are followed by a step of destaining the biological sample by means of the stainer and iteratively repeating the steps of staining the biological sample, transporting the carrier, imaging the stained biological sample, and destaining the biological sample. This iterative staining enables subsequently applying a large number of different markers, in order to identify a larger number of target analytes within the samples. By providing the samples on sample holders in carriers, a larger number of samples may be analysed by means of the analysis system and the method.

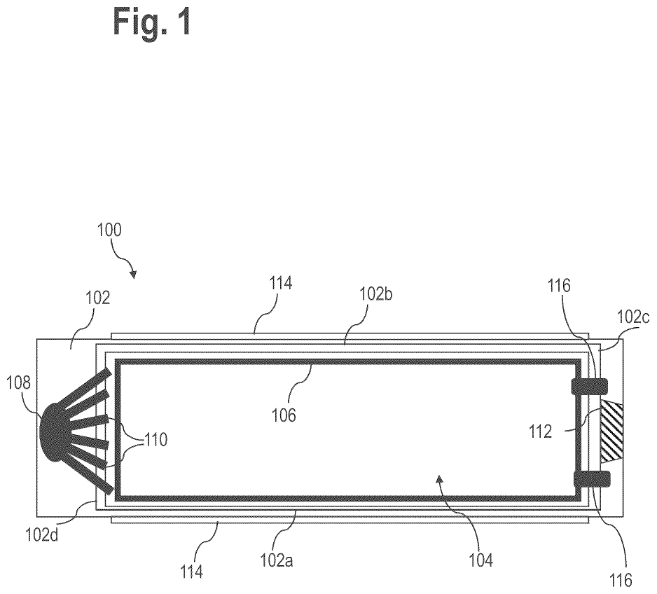

FIG. 1 is a schematic top view of a carrier 100 for a sample holder. The carrier 100 comprises a frame 102, which surrounds a holding space 104 to receive the sample holder. The frame 102 has an essentially rectangular shape with two opposing long sides 102a, 102b and two opposing short sides 102c, 102d. In particular, the two short sides 102c, 102d may extend in an x-direction and the two long sides 102a, 102b may extend in a y-direction. Moreover, all sides 102a, 102b, 102c, 102d of the frame 102 may be arranged in the same plane, in particular, the plane extends in the x-direction and the y-direction. The holding space 104 extends between the two long sides 102a, 102b and the two short sides 102c, 102d of the frame 102 and therefore the holding space 104 also extends in the x-direction and the y-direction. In addition, the frame 102, in particular, the sides 102a, 102b, 102c, 102d, and therefore the holding space 104 extend in a z-direction. The carrier may optionally comprise a circumferential seal 106, which extends along the sides 102a, 102b, 102c, 102d.

The carrier 100 may further comprise a liquid inlet 108. The liquid inlet 108 is arranged at least partially in one of the short sides 102d of the frame 102. Alternatively, the liquid inlet 108 may be arranged in any other of the sides 102a, 102b, 102c of the frame 102. The liquid inlet 108 enables streaming a fluid into the holding space 104. To that end, the liquid inlet 108 is in fluid communication with the holding space 104. Preferably, the liquid inlet 108 has a distribution section 110 that distributes any liquid flowing through the liquid inlet 108 into the holding space 104 across essentially the side 102d the liquid inlet 108 is arranged in. The carrier 100 may further comprise a liquid outlet 112. The liquid outlet 112 is arranged in the side 102c of the frame 102, preferably it is arranged in the side 102a, 102b, 102c, 102d opposite the side 102a, 102b, 102c, 102d that the liquid inlet 110 is arranged in. The liquid outlet 112 is configured to remove liquid from the holding space 102. To that end, the liquid outlet 112 is in fluid connection with the holding space 102. Thus, liquid may be streamed into the holding space 102 through the liquid inlet 108 and streamed out of the holding space 102 through the liquid outlet 112.

The carrier 100 further comprises at least one handling structure 114, specifically, the carrier 100 comprises two handling structures 114, one arranged on each long side 102a, 102b. The handling structures 114 are arranged on a surface of the long sides 102a, 102b that faces away from the holding space 104. Alternatively, the handling structure may be arranged at a different position on the frame 102 of the carrier 100. The handling structure 114 of the carrier 100 is an edge protruding from the surface of the long sides 102a, 102b and fixedly connected to the long sides 102a, 102b. The handling structure 114 is configured to be engaged by a handling device in order to move the carrier 100 at least in the x-and the y-direction, preferably, also in the z-direction.

Alternatives for the handling structure 114 may include a recessed portion arranged in the frame 102 of the carrier. In addition, or as a further alternative, the handling structure 114 may comprise a rubberised surface on the frame 102 of the carrier 100.

The carrier 100 may further comprise at least one holding element 116 configured to hold the sample holder in the holding space 104.

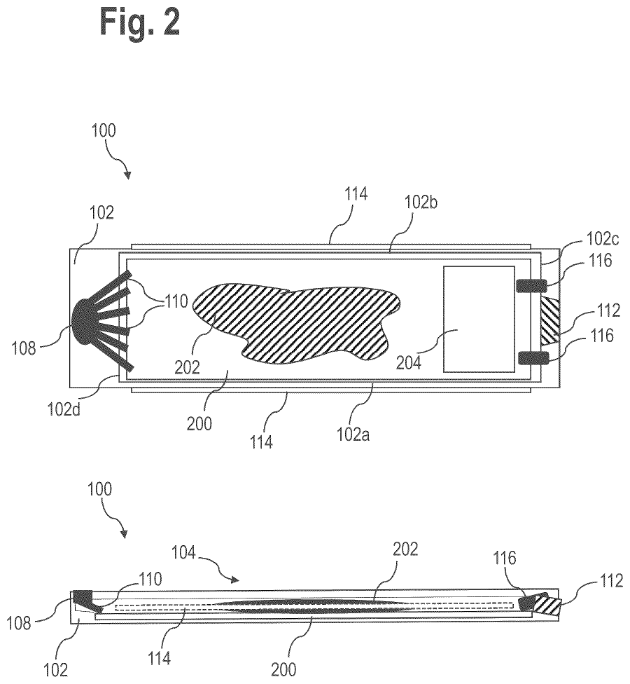

FIG. 2 is a schematic top view and side view of the carrier 100 and a sample holder 200 that is arranged in the holding space 104 of the carrier 100. The sample holder 200 is a microscope slide, for example, and may be made from glass. On one surface of the sample holder 200, a sample 202, for example, a biological sample such as a tissue section, may be arranged in a sample area of the sample holder 200. The sample holder 200, in particular the sample area, is transparent such that the sample 202 on the sample holder 200 may be viewed from the side of the sample holder 200 that the sample 202 is arranged on and may be viewed from an opposing side through the sample holder 200. Further, the sample holder 200 may comprise a label 204, that may be readable electromagnetically, in particular, optically. The label 204 may be used to identify the sample holder 200, in particular, the sample 202 on the sample holder 200, from a plurality of sample holders. For example, the label 204 may be a barcode or an RFID-tag.

The sample holder 200 may be inserted into the carrier 100, in particular, into the holding space 104. When the sample holder 200 is inserted into the carrier 100, one surface of the sample holder 200 is partially arranged on the seal 106 or on a circumferential protrusion of the sides 102a, 102b, 102c, 102d. The sample 202 is arranged on an opposing surface of the sample holder 200. The holding element 116 may press the sample holder 200 against the seal 106. The sides 102a, 102b, 102c, 102d partially enclose the sample holder 200, in particular, the frame 102 encloses only edges of the sample holder 200.

When the sample holder 200 is inserted in the carrier 100, the sample holder 200 preferably is in a recessed position within the frame 102 of the carrier 100. In particular, the sides 102a, 102b, 102c, 102d of the frame 102 have a height in the z-direction greater than a height of the sample holder 200. Thus, the holding space 104 has dimensions in the x-, y- and z-directions such that the sample holder 200 may be inserted into and accommodated by the holding space 104. Further, this ensures that any liquid streamed into the holding space 104 through the liquid inlet 108 may be contained above the sample holder 200. In particular, the surface of the sample holder 200 on which the sample 202 is arranged may therefore be submerged in liquid, in particular, the sample 202 may be submerged in liquid.

Further, the sides 102a, 102b, 102c, 102d of the frame 102 are arranged to enable observation of at least the sample 202 of the sample holder 200 by means of an imager. In particular, the frame 102 does not impede viewing the sample 202 from the side of the sample holder 200 that the sample 202 is arranged on and the frame 102 does not impede viewing the sample 202 from an opposite side of the sample holder 200 through the sample holder 200.

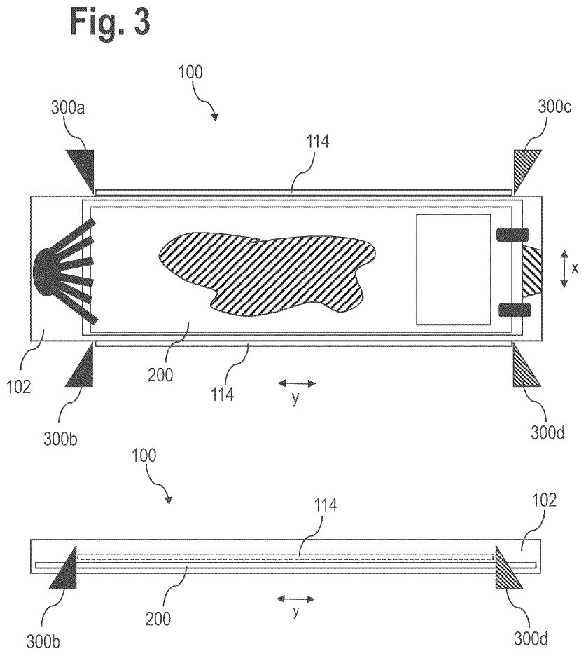

FIG. 3 is a schematic top view and a side view of the carrier 100 with the sample holder 200 and a handling device. The handling device comprises four interaction elements 300a, 300b, 300c, 300d and is configured to engage the handling structure 114 of the carrier 100. Specifically, the interaction elements 300a, 300b, 300c, 300d each engage an edge of the handling structure 114. In particular, a pair of interaction elements 300a, 300b, 300c, 300d may engage one of the handling structure 114, with the interaction elements 300a, 300b, 300c, 300d of one pair engaging the respective handling structure 114 at opposite ends. Each interaction element 300a, 300b, 300c, 300d may push the carrier 100 in a direction along a longitudinal axis of the respective handling structure 114 and in a direction perpendicular to that longitudinal axis. By combining and coordinating the directions that each of the interaction elements 300a, 300b, 300c, 300d may push the carrier 100, the carrier may be pushed by the interaction elements 300a, 300b, 300c, 300d in any combination of the x-direction and the y-direction already referred to in conjunction with FIG. 1.

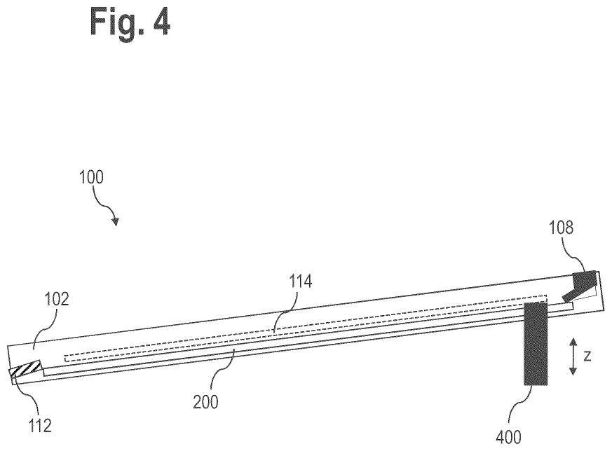

FIG. 4 is a schematic side view of the carrier 100 with the sample holder 200 and a handling device with an interaction element 400. The interaction element 400 is configured to engage the handling structure 114, in particular, engage a bottom surface of the handling structure 114, in order to push the carrier 100 in the z-direction. At least a second interaction element 400 can be provided that is concealed in FIG. 4 and that pushes against the second handling structure 114 in order to lift the carrier uniformly. The lifting of the carrier 100 at a side where the liquid inlet 108 is arranged angles the carrier 100 from the liquid inlet 108 to the liquid outlet 112. This enables that liquid that is streamed into the holding space 104 through the liquid inlet 108 flows out of the holding space 104 through the liquid outlet 112 by gravity.

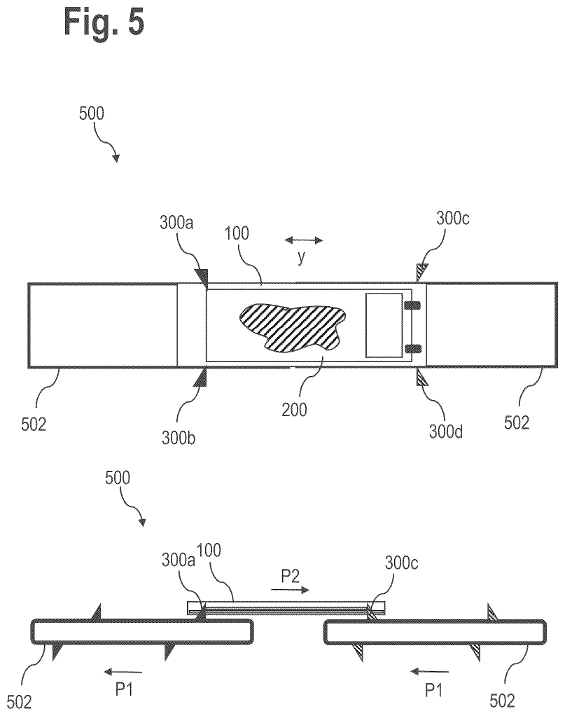

FIG. 5 is a schematic top view and a side view of a transporter 500 for transporting carriers 100. The transporter 500 comprises two belts 502, in particular, conveyor belts 502, and at least one motor configured to turn the conveyor belts 502. Further, the transporter 500 comprises a handling device with a plurality of interaction elements 300a, 300b, 300c, 300d, specifically, the interaction elements 300a, 300b, 300c, 300d are fixedly connected with the conveyor belts 502. Thus, when the conveyor belts 502 move, the respective interaction elements 300a, 300b, 300c, 300d move with the conveyor belts 502. In FIG. 5, the interaction elements that are in contact with the carrier 100 are indicated by reference signs 300a, 300b, 300c, 300d. The transporter 500 may comprise additional interaction elements. As explained in conjunction with FIG. 3, the interaction elements 300a, 300b, 300c, 300d engage one of the handling elements 114 of the carrier 100. Thus, the movement of the conveyor belts 502 may be translated to the carrier 100 by means of the engaged interaction elements 300a, 300b, 300c, 300d. In addition to the movement of the carrier 100 by means of the interaction elements 300a, 300b, 300c, 300d, the carrier 100 is arranged on the conveyor belt 502 itself, thus, the conveyor belt 502 may carry the carrier 100. The movement of the conveyor belts 502 is indicated by arrows P1 and the corresponding movement of the carrier 100 is indicated by arrow P2.

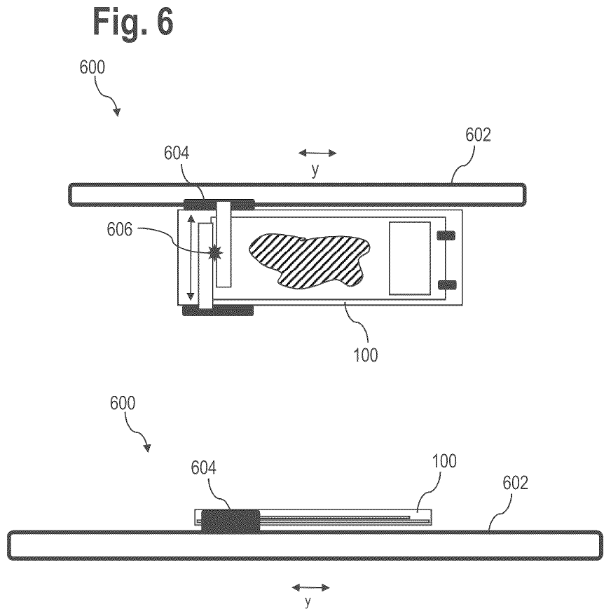

FIG. 6 is a schematic top view and a side view of a transporter 600 for transporting carriers 100. The transporter 600 comprises a belt 602 that comprises a handling device with interaction elements 604 fixedly connected to the belt 602. The interaction elements 604 may be opened and closed by means of a gripping mechanism comprising a gearwheel 606, for example. When the gripping mechanism is in a closed position, each of the interaction elements 604 is engaged with the respective handling structure 114 of the carrier 100. The interaction elements 604 may be moved in the x-direction by means of the belt 602, when the interaction elements 604 are engaged with the handling structure 114 of the carrier 100, the carrier 100 is moved correspondingly.

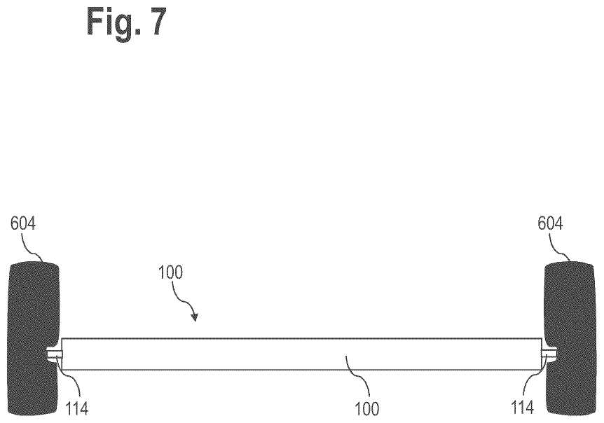

FIG. 7 is a schematic side view of the carrier 100 with engaged interaction elements 604 of the transporter 600. The view in FIG. 7 of carrier 100 is towards one of the short sides 102c, 102d. The interaction elements 604 have a groove or a recessed portion configured to engage the handling structures 114 protruding from the frame 102 of the carrier 100. Alternatively or additionally, the handling structures 114 may comprise a rubberised surface configured to be engaged by the interaction elements 604.

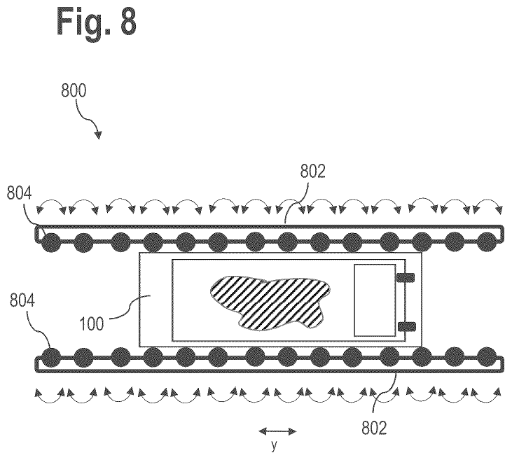

FIG. 8 is a top view of a transporter 800 for transporting carriers 100. Further, the transporter 800 comprises a handling device comprising a belt 802 and a plurality of wheels 804. The wheels 804 may engage the handling structure 114 of the carrier 100. Each wheel 804 may rotate about a rotation axis, the rotation axes of the wheels 804 remaining stationary when the carrier 100 is transported. The wheels 804 may be driven to rotate about their rotation axes by means of the belt 802. Thus, the wheels 804 may move the carrier 100 when the wheels 804 are engaged with the carrier 100.

The handling structure 114 of the carrier 100 may alternatively be a rubberised surface configured to engage with the wheels 804, or a ribbed surface configured to engage a correspondingly ribbed surface of the wheels 804. In a further alternative, the wheels 804 may comprise a recessed portion around their circumference that is configured to engage the handling structure 114 of the carrier 100.

The transporter 500, 600, 800 may additionally comprise one of a tongue or a groove and the carrier 100 may comprise the other of a tongue or a groove. The tongue and groove may engage with each other in order to keep the carrier 100 aligned with the transporter 500, 600, 800 when the carrier 100 is transported by the transporter 500, 600, 800.

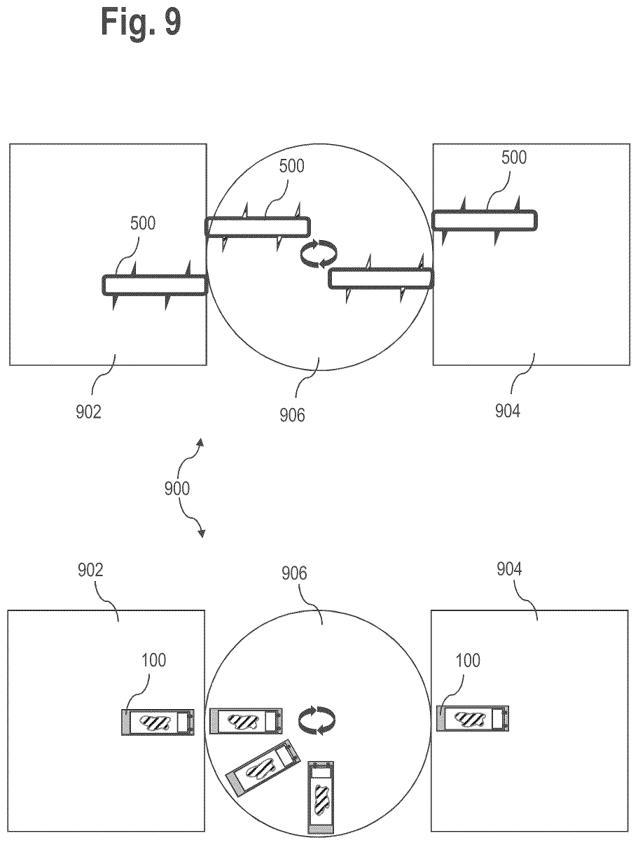

FIG. 9 is a schematic view of an analysis system 900 comprising several of the transporters 500 for transporting the carrier 100. Alternatively or additionally, the analysis system 900 may comprise the transporters 600, 800.

The analysis system 900 further comprises a stainer 902 and an imager 904. The stainer 902 is configured to stain and/or destain the sample 202 on the sample holder 200 carried in the carrier 100. The imager 904 is configured to image the sample 202 on the sample holder 200 carried in the carrier 100. Further, the transporters 500 are configured to transport the carriers 100 with sample holders 200 and samples 202 between the stainer 902 and the imager 904. Thus, the sample 202 on the sample holder 200 in the carrier 100 may be stained in the stainer 902. Subsequently, the stained sample 202 on the sample holder 200 in the carrier 100 may be transported by means of the transporters 500 to the imager 904. The stained sample 202 on the sample holder 200 in the carrier 100 may then be imaged by the imager 904.

The analysis system 900 may optionally comprise a carousel transporter arrangement 906. The carousel 906 comprises a plurality of transporters 500 in order to move a plurality of carriers 100 efficiently between at least the stainer 902 and the imager 904.

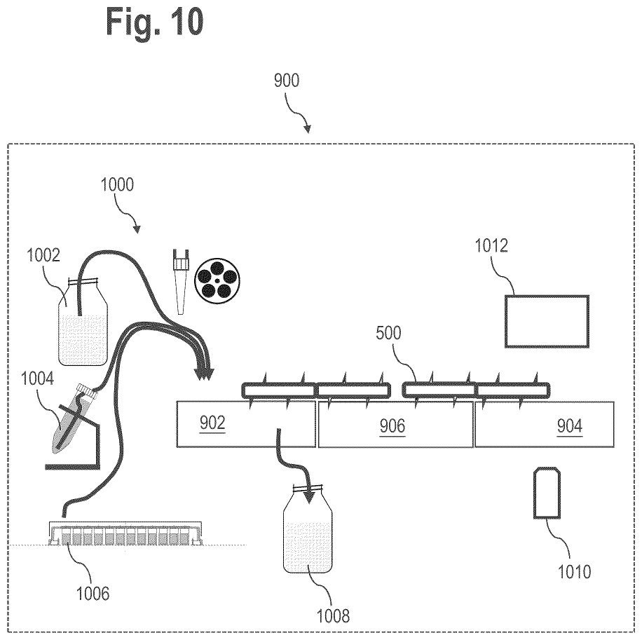

FIG. 10 is a detailed schematic view of the analysis system 900. The stainer 902 may comprise a liquid handling device 1000. The liquid handling device 1000 may comprise buffer flasks 1002 for storing wash buffers or destaining buffers. Further, the liquid handling device 1000 may comprise reagent storage containers 1004, 1006, for example, for antibody-based fluorescent markers and/or for FISH-probes. These wash buffers and markers may be applied to the sample 202 on the sample holder 200 in the carrier 100. Specifically, the buffer flask 1002 and the reagent storage 1004, 1006 may be fluidly connected to the liquid inlet 108 of the carrier 100 when the carrier 100 has been transported to the stainer 902. The liquid handling device 1000 may further comprise a wash flask 1008 for storing runoff liquids from the staining process. The wash flask 1008 may be fluidly connected to the liquid outlet 112 of the carrier 100 when the carrier 100 has been transported in the stainer 902. The liquid handling device 1000 may comprise at least one pump for pumping respective liquids to and from the carrier 100.

The imager 904 may be a microscope and comprise a microscope stage, imaging optics 1010 and illumination light source 1012. Thus, the sample 202 on the sample holder 202 in the carrier 100 may be illuminated and imaged by the imager 904. In particular, the sample 202 stained with fluorescent markers by the stainer 902 may be transported to the imager 904 and illuminated by excitation light to excite the fluorescent markers and the excitation light may be detected by the imager 904.

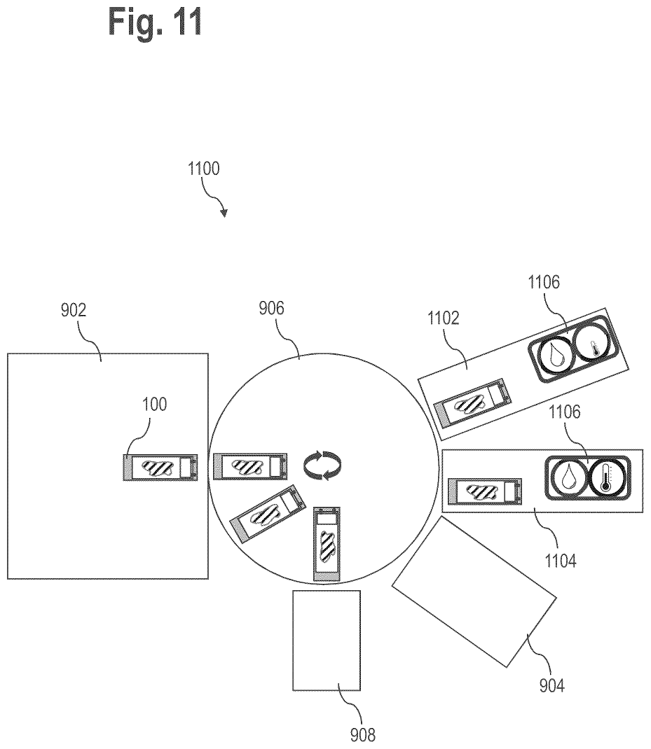

FIG. 11 is a schematic view of an analysis system 1100. In addition to the transporters 500, the stainer 902, and the imager 904, the analysis system 1100 further comprises a first storing unit 1102 and a second storing unit 1104. The storing units 1102, 1104 each comprise a climate control device 1106. The climate control devices 1106 enables control of the climate within the storing units 1102, 1104. For example, by means of the climate control devices 1106 a temperature, a humidity or a pressure, in particular, an air pressure, within a closed storing space within the storing units 1102, 1104 may be controlled at a predetermined setpoint.

As an example, the climate control devices 1106 of each of the storing units 1102, 1104 may be set at particular conditions that enable an increase in staining speed or efficiency. In particular, the stainer 902 may apply antibody-based fluorescent markers or FISH-probes to the sample 202 in the carrier 100, which is then transported by the transporter 500 to either the storing unit 1102 with climate conditions set for staining with antibody-based fluorescent markers or to the storing unit 1104 with climate conditions set for staining with FISH-probes. The carrier 100 may then be stored within the respective storing unit 1102, 1104 and the sample 202 incubated at conditions that enable the staining reaction to proceed or to complete efficiently based on the marker applied to the respective sample 202.

In addition, the sample 202 on the sample holder 200 in the carrier 100 may be incubated within the storing unit 1102, 1104 for a pre-set amount of time. For example, a particular marker applied to the sample 202 may be known to require incubation with the sample 202 for a pre-set amount of time before staining is complete. After the pre-set amount of time is over, the carrier 100 with the sample 202 may then be transported by means of the carousel 906 to the imager 904 in order to image the sample 202.

As a further example, the climate control devices 1106 of each of the storing units 1102, 1104 may be set at humidity conditions that minimise or prevent the evaporation of liquids in the holding space 104 of the sample holder 200 or the drying-out of the sample 202 on the sample holder 200.

Moreover, the analysis system 1100 may optionally comprise an access point 908 for entering carriers 100 into the analysis system 1100. The access point 908 is configured to receive carriers 100 to be processed by the analysis system 1100. Thus, the carousel 906 may transport the carrier 100 from the access point 908 to the stainer 902 to stain the sample 202 on the carrier 100, for example. Preferably, the access point 908 comprises a scanner configured to scan the label 204 of the carrier 100. This enables identifying the carriers 100 entered into the analysis system 1100.

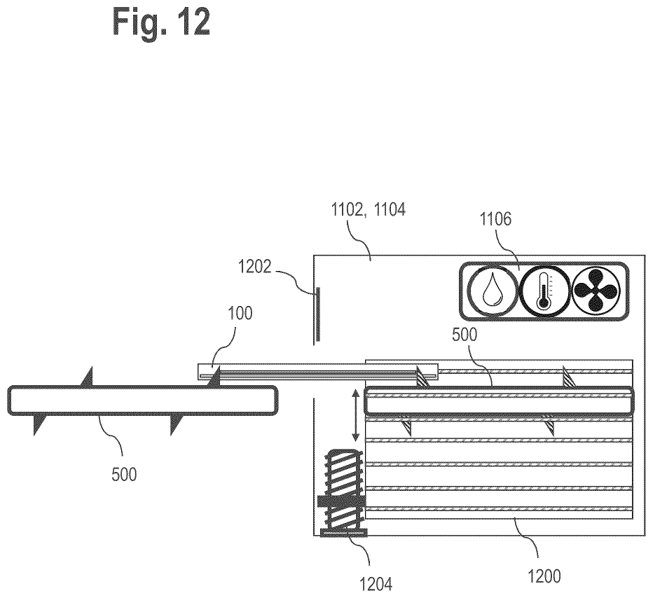

FIG. 12 is a detailed schematic view of the storing units 1102, 1104. The storing units 1102, 1104 may optionally comprise a rack section 1200 for storing a plurality of carriers 100. The carriers 100 may enter the storing unit 1102, 1104 through a sliding door 1202. In a closed state of the door 1202, the storing unit 1102, 1104 is sealed such that the climate within the storing unit 1102, 1104 may be controlled by the climate control device 1106. In an open state of the door 1202, the carriers 100 may be transported into and out of the storing unit 1102, 1104 by means of transporters 500. A drive 1204, in particular a worm drive, may be provided to move the carrier 100 to a position in the rack section 1200.

The climate control device 1106 may control an air temperature within the storing unit 1102, 1104. The temperature of the carriers 100 may therefore be essentially determined by convection. In addition or alternatively, heating elements may be provided on the rack section 1200, that are in contact with carriers 100 stored on the rack section 1200. These heating elements may control the temperature of the carriers 100 on the rack section 1200 essentially by conduction. Preferably, these heating elements may control the temperature of individual carriers 100 independently of each other. Further, these heating elements may be configured to heat the carriers 100 in cycles, for example, for PCR.

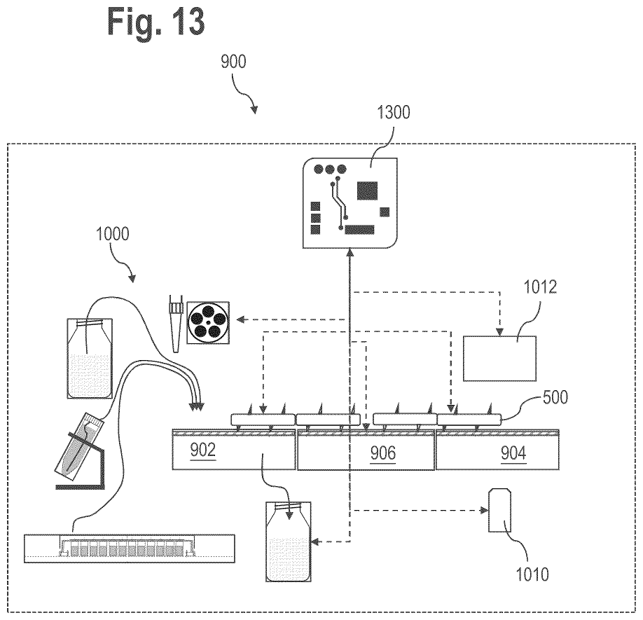

FIG. 13 is a schematic view of the analysis system 900 with an operating unit 1300. The operating unit 1300 is configured to control at least the stainer 902, the imager 904 and the transporter 500, preferably also the carousel 906. The operating unit 1300 may comprise a single panel for input and output to a user of the analysis system 900. Further the operating unit 1300 may be configured to carry out a method for analysing the biological sample 202. Similarly, the analysis system 1100 may comprise the operating unit 1300.

Further, the operating unit 1300 may be configured to track individual carriers 100 with sample holders 200 and samples 202, in particular, their position, throughout the analysis system 900.

In addition, the analysis system 900, 1100 may comprise means, such as an optical reader or an RFID reader, to read-out the label 204 of the sample holder 200. This enables particularly efficient identifying and tracking individual carriers 100 with sample holders 200 and samples 202 throughout the analysis system 900.

A method for analysing a biological sample includes the steps: providing at least one biological sample 202 on a sample holder 200 in a carrier 100; staining the biological sample 202 by means of the stainer 902; transporting the carrier 100 with the stained biological sample 202 to the imager 904 by means of the transporter 500, in particular, the carousel 906; and imaging the stained biological sample 202 by means of the imager 904. The method provides an efficient process for staining a large number of individual samples 202 by providing them on individual carriers 100 that may be shuttled through the analysis system 900 by the transporter 500 or carousel 906 and subsequently imaging the samples 202 by means of the imager 904.

During the step of staining the sample 202, the carrier 100 with the sample 202 may be transported by the transporter 500, in particular, the carousel 906, to the storing unit 1102, 1104 appropriate for the respective marker in order to incubate the sample 202 with the marker. In order to direct the carrier 100 to the appropriate storing unit 1102, 1104, the step of staining may further include identifying the carrier based on its label 204 or based on its position within the transporter 500, in particular, the carousel 906. Further, the step of staining may further include incubating the carrier 100 with the sample 202 for a pre-set amount of time. After the pre-set amount of time is over, the carrier 100 is retrieved from the storing unit 1102, 1104 by means of the transporter 500, in particular, the carousel 906, and transported to the imager 904 for imaging the sample 202.

Identical or similarly acting elements are designated with the same reference signs in all Figures. As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

100 Carrier
102 Frame
102a, 102b, 102c, 102d Sides of frame
104 Holding space
106 Seal
108 Liquid inlet
110 Distribution section of liquid inlet
112 Liquid outlet
114 Handling structure
116 Holding element
200 Sample holder
202 Sample
204 Label
300a, 300b, 300c, 300d, 400, 604 Interaction element
500, 600, 800 Transporter
502, 602, 802 Belt
606 Gearwheel
804 Wheel
900, 1100 Analysis system
902 Stainer
904 Imager
906 Carousel transporter arrangement
908 Access point
1000 Liquid handling device
1002 Buffer flask
1004, 1006 Reagent storage
1008 Wash flask
1010 Imaging optics
1012 Illumination light source
1102, 1104 Storing unit
1106 Climate control device
1200 Rack section
1202 Sliding door
1204 Drive
1300 Operating unit

1. A carrier for a sample holder, the carrier comprising:
a frame defining a holding space to receive the sample holder,
wherein the frame is configured to enclose the sample holder at least partially on a plurality of sides,
wherein the frame is configured to enable visual inspection of at least a sample area of the sample holder and
wherein the frame comprises at least one handling structure configured to be engaged by a handling device.

2. The carrier according to claim 1, wherein the frame comprises a circumferential seal configured to seal against the sample holder.

3. The carrier according to claim 1, wherein the frame comprises a liquid inlet configured to stream a liquid into the holding space.

4. The carrier according to claim 3, wherein the liquid inlet comprises a distribution section configured to evenly distribute the liquid at least across the sample area of the sample holder.

5. The carrier according to claim 3, wherein the frame comprises a liquid outlet configured to remove the liquid from the holding space.

6. The carrier according to claim 1, wherein the frame is configured to receive the sample holder in a recessed position within the frame.

7. The carrier according to claim 1, further comprising at least one holding element configured to hold the sample holder in the holding space.

8. The carrier according to claim 1, wherein the handling structure is fixedly connected to the frame.

9. The carrier according to claim 1, wherein the handling structure is configured to be engaged by the handling device by friction fit and/or by form fit.

10. A transporter, for transporting the carrier according to claim 1, the transporter comprising:
at least one transport belt,
a drive configured to move the at least one transport belt, and
at least one handling device configured to engage the at least one handling structure of the carrier.

11. The transporter according to claim 10, wherein the handling device is fixedly connected to the at least one transport belt,

12. The transporter according to claim 11, wherein the at least one transport belt comprises one of a tongue or a groove configured to engage a complementary tongue or a complementary groove arranged on the carrier.

13. The transporter according to claim 11, wherein the handling device comprises a plurality of wheels configured to engage the at least one handling structure of the carrier.

14. The transporter according to claim 11, wherein the handling device is stationary.

15. An analysis system for analysing biological samples_ the analysis system comprising:
a stainer configured to receive the carrier according to claim 1 and to stain a biological sample in the sample area of the sample holder receivable by the carrier,
an imager configured to receive the carrier and to image the biological sample in the sample area, and
at least one transporter configured to transport the carrier between the stainer and the imager the at least one transporter comprising at least one transport belt, a drive configured to move the at least one transport belt, and at least one handling device configured to engage the at least one handling structure of the carrier.

16. The analysis system according to claim 15, wherein the stainer comprises a liquid handling device configured to engage liquid inlet and a liquid outlet of the carrier.

17. The analysis system according to claim 15, further comprising at least one storing unit configured to receive and to store the one-carrier

18. The analysis system according to claim 17, wherein the storing unit, comprises a climate control device configured to control at least one of a temperature, a humidity, or a pressure within the storing unit.

19. The analysis system according to claim 15, further comprising an operating unit configured to control the stainer, the imager, and the at least one transporter.

20. A method for analysing a biological sample by using the analysis system according to claim 15, the method comprising:
providing the biological sample on the sample holder in the carrier,
staining the biological sample by using the stainer,
transporting the carrier with the stained biological sample to the imager by using the transporter, and
imaging the stained biological sample by using the imager.

21. The method according to claim 20, wherein the staining the biological sample comprises transporting the carrier to a storing unit of the analysis system by using the transporter in order to incubate the biological sample.

22. The method according to claim 20, further comprising, following the staining the biological sample the transporting the carrier, and the imaging the stained biological sample, destaining the biological sample by using the stainer, and iteratively repeating the staining the biological sample, the transporting the carrier, the imaging the stained biological sample, and the destaining the biological sample.
